(19) United States
(12) Patent Application Publication
(10) Pub. No.: US 2006/0183476 A1
(43) Pub. Date: Aug. 17, 2006

(54) Mobile communication terminal and communication management apparatus

(75) Inventors: Junichi Morita, Hachioji-shi (JP); Toshio Oka, Yokohama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd, Kadoma-shi, Osaka (JP)

(21) Appl. No.: 10/566,108

(22) PCT Filed: Aug. 20, 2004
(86) PCT No.: PCT/JP04/12314

§ 371 Date: Jan. 26, 2006

(30) Foreign Application Priority Data
Oct. 29, 2003 (JP) 2003368461

(51) Int. Cl. H04Q 7/20

(52) U.S. Cl. 455/435.2

(57) ABSTRACT

An object of the present invention is to provide a mobile communication terminal which can perform communication by a plurality of communication systems and which can change over communication from communication using a current communication system to communication using another communication system while taking a status of a destination terminal engaging in communication into consideration, and communication management apparatus for managing communication made by the mobile communication terminal.

In order to solve the foregoing problem, the communication management apparatus according to the present invention is a cellular phone (101) capable of performing communication by a plurality of communication systems, wherein the plurality of communication systems include a WCDMA system and a communication system based on SIP (system for allowing an IP call), and the cellular phone (101) includes a WCDMA communication module (134) for making communication with a cellular phone (102) by the WCDMA system, a wireless LAN communication module (136) for performing communication with the cellular phone (102) by the communication system based on SIP, and a general control portion (141) for controlling the cellular phone (101) as a whole. The general control portion (141) determines whether the cellular phone (101) is or not within a hot spot as an area where communication can be made by the communication system based on SIP, during communication with the cellular phone (102) based on the WCDMA system. The general control portion (141) determines whether the cellular phone (102) is within a hot spot or not. When the general control (141) concludes that both the cellular phone (101) and the cellular phone (102) are within the hot spots, the general control portion (141) gives a wireless LAN communication control portion (142) an instruction to establish communication using the communication system based on SIP. Then, the general control portion (141) gives a WCDMA communication control portion (143) an instruction to cut off communication using the WCDMA system.

### TECHNICAL FIELD

The present invention relates to a mobile communication terminal capable of making communication by a plurality of communication systems, and communication management apparatus managing the communication.

### BACKGROUND ART

In recent years, fixed IP phones using an IP network are coming into wide use. A call-using the IP network has an advantage of a cheaper charge for the call than that by any other communication system (e.g. WCDMA system). Also in the field of mobile communication, users can obtain a great merit if a call using an IP network can be provided when mobile communication terminals are present in so-called hot spots, that is, areas for allowing IP connection.

However, communication areas of the hot spots are extremely narrow and lie scattered, compared with those in another communication system (e.g. WCDMA system). For this reason, when a mobile communication terminal engaging in a call using the WCDMA system is moving physically, it is estimated that the mobile communication terminal sometimes goes into a hot spot and sometimes goes out of the hot spot. In this case, a technique for changing over the communication system from the WCDMA system to the IP system (or vice versa) is required in order not to disconnect the call.

As such a technique for changing over the communication system, there is known a technique for realizing so-called handover, in which communication is continued by automatically changing over from one base station to another when a mobile communication terminal engaging in a call using one communication system moves to a communication area using another communication system (e.g. see Patent Document 1). Patent Document 1 has disclosed a configuration as follows. That is, when a mobile communication terminal engaging in communication moves to a service region where two wireless communication systems overlap, conditions for realizing handover are prepared. In this stage, an environment adapted for a new wireless communication system is arranged. Communications in the new and old wireless communication systems are activated respectively. Then, communication connection using the wireless communication system with electric field intensity being not higher than a threshold is cut off while communication using the remaining wireless communication system is continued. Thus, handover between different kinds of wireless communication systems is performed smoothly.

In addition, there is also know a communication system for automatically changing over between a call based on circuit switching and an IP call at the time of starting the call (e.g. see Patent Document 2).

(Patent Document 1) JP-A-2002-291011 (paragraphs 0113 to 0172)

(Patent Document 2) JP-A-2001-251440

### DISCLOSURE OF THE INVENTION

Although Patent Document 1 has disclosed a technique for performing handover between a source terminal and a base station when the source terminal moves from a communication area using a communication system to a communication area using another communication system, there is no suggestion about how to perform handover in consideration of a destination terminal engaging in the communication.

An object of the present invention is to provide a mobile communication terminal which can perform communication by a plurality of communication systems and which can change over communication from communication using a current communication system to communication using another communication system while taking a status of a destination terminal engaging in the communication into consideration, and communication management apparatus for managing communication made by the mobile communication terminal.

The mobile communication terminal according to the present invention is a mobile communication terminal capable of performing communication by a plurality of communication systems include a first communication system and a second communication system, a first wireless communication region where communication can be made by the first communication system is wider than a second wireless communication region where communication can be made by the second communication system, the mobile communication terminal comprises first communication means for performing communication with a destination terminal by the first terminal method, second communication means for performing communication with the destination terminal by the second communication system, first determination means for determining whether the mobile communication terminal is within the second wireless communication region or not during communication with the destination terminal, second determination means for determining whether the destination terminal is within the second wireless communication region or not during communication with the destination terminal, and communication changeover control means for performing control to change over between communication made by the first communication means and communication made by the second communication means, based on at least one of a determination result of the first determination means and a determination result of the second determination means.

In the mobile communication terminal according to the present invention, the communication changeover control means performs control to change over from communication made by the first communication means to communication made by the second communication means when the first determination means concludes that the mobile communication terminal is within the second wireless communication region during communication with the destination terminal by the first communication means and the second determination means concludes that the destination terminal is within the second wireless communication region.

With this configuration, communication between the mobile communication terminal and the destination terminal is changed over from communication made by the first communication means to communication made by the second communication means when both the mobile communication terminal and the destination terminal go into the second wireless communication region during the communication made by the first communication means. Thus, even when the mobile communication terminal and the destination terminal are engaging in communication with each other, the communication can be changed over to communication using another communication system.

In the mobile communication terminal according to the present invention, the communication changeover control means performs control to cut off a line connected to the destination terminal by the first communication means after line connection to the destination terminal by the second communication means is completed.

With this configuration, the line connected to the destination terminal by the first communication means is cut off after the line connection to the destination terminal by the second communication means is completed. Thus, it is possible to prevent communication from being disconnected.

The mobile communication terminal according to the present invention further includes resumption control means for resuming the second communication means when the first determination means concludes that the mobile communication terminal is within the second wireless communication region during communication with the destination terminal by the first communication means, and suspending the first communication means after the line connected to the destination terminal by the first communication means is cut off.

With this configuration, the first communication means and the second communication means are always prevented from being activated simultaneously. Thus, it is possible to achieve low power consumption.

In the mobile communication terminal according to the present invention, when the first determination means concludes that the mobile communication terminal is out of the second wireless communication region during communication with the destination terminal by the second communication means, the communication changeover control means performs control to change over from communication made by the second communication means to communication made by the first communication means.

In the mobile communication terminal according to the present invention, the communication changeover control means performs control to change over from communication made by the second communication means to communication made by the first communication means when the second determination means concludes that the destination terminal is out of the second wireless communication region during communication with the destination terminal by the second communication means.

With this configuration, communication between the mobile communication terminal and the destination terminal is changed over from communication made by the second communication means to communication made by the first communication means when either the mobile communication terminal or the destination terminal goes out of the second wireless communication region during the communication made by the second communication means. Thus, even when the mobile communication terminal and the destination terminal are engaging in communication with each other, the communication can be changed over to communication using another communication system.

In the mobile communication terminal according to the preset invention, the communication changeover control means performs control to cut off the line connected to the destination terminal by the second communication means after the line connection to the destination terminal by the first communication means is completed.

In the mobile communication terminal according to the present invention, the communication changeover control means performs control to cut off the line connected to the destination terminal by the second communication means after the line connection to the destination terminal by the first communication means is completed.

With this configuration, the line connected to the destination terminal by the second communication means is cut off after the line connection to the destination terminal by the first communication means is completed. Thus, it is possible to prevent communication from being disconnected.

The mobile communication terminal according to the present invention further includes resumption control means for resuming the first communication means when the first determination means concludes that the mobile communication terminal is out of the second wireless communication region during communication with the destination terminal by the second communication means, and suspending the second communication means after the line connected to the destination terminal by the second communication is cut off.

The mobile communication terminal according to the present invention further includes resumption control means for resuming the first communication means when the second determination means concludes that the destination terminal is out of the second wireless communication region during communication with the destination terminal by the second communication means, and suspending the second communication means after the line connected to the destination terminal by the second communication is cut off.

With this configuration, the first communication means and the second communication means are always prevented from being activated simultaneously. Thus, it is possible to achieve low power consumption.

In the mobile communication terminal according to the present invention, the first determination means determines that the mobile communication terminal is within the second wireless communication region during communication with the destination terminal by the first communication means, based on mobile communication terminal within-region notification information for notifying that the mobile communication terminal is within the second wireless communication region, the notification information being sent from communication management apparatus for managing communication between the mobile communication terminal and the destination terminal, and the second determination means determines that the destination terminal is within the second wireless communication region during communication with the destination terminal by the first communication means, based on destination terminal within-region notification information for notifying that the destination terminal is within the second wireless communication region, the notification information being sent from the communication management apparatus.

The mobile communication terminal according to the present invention further includes radio wave intensity detection means for detecting intensity of a radio wave received by the second communication means during communication with the destination terminal through the second communication means, wherein the first determination means determines whether the mobile communication terminal is within the second wireless communication region or not during communication with the destination terminal by the second communication means, based on the radio wave intensity detected by the radio wave intensity detection means.

In the mobile communication terminal according to the present invention, the second determination means concludes that the destination terminal is out of the second wireless communication region during communication with the destination terminal by the second communication means, based on destination terminal out-of-region notification information for notifying that the destination terminal is out of the second wireless communication region, the notification information being sent from communication management apparatus for managing communication between the mobile communication terminal and the destination terminal.

In the mobile communication terminal according to the present invention, the second communication system is a communication system based on SIP,

The communication management apparatus according to the present invention is communication management apparatus for managing communication between two mobile communication terminals performing the communication by a plurality of communication systems, wherein the two mobile communication terminals are set as a source terminal and a destination terminal respectively, wherein the plurality of communication systems include a first communication system and a second communication system, a first wireless communication region in which communication can be made by the first communication system is wider than a second wireless communication region in which communication can be made by the second communication system, and wherein the communication management apparatus comprises position information detection means for detecting position information of the source terminal and the destination terminal, within-region determination means for determining whether the source terminal and the destination terminal are within the second wireless communication region or not during communication between the source terminal and the destination terminal, based on region information of the second wireless communication region and the position information, and notification information transmission means for transmitting the source terminal notification information for notifying a determination result of the within-region determination means.

In the communication management apparatus according to the present invention, the notification information contains source terminal within-region notification information for notifying that the source terminal is within the second wireless communication region during communication between the source terminal and the destination terminal by the first communication system, and destination terminal within-region notification information for notifying that the destination terminal is within the second wireless communication region during communication between the source terminal and the destination terminal by the first communication system.

In the communication management apparatus according to the present invention, the notification information contains destination terminal out-of-region notification information for notifying that the destination terminal is out of the second wireless communication region during communication between the source terminal and the destination terminal by the second communication system.

In the communication management apparatus according to the present invention, the second communication system is a communication system based on SIP.

### BRIEF DESCRIPTION OF THE DRAWINGS

FIG. 1 is a diagram showing the schematic configuration of a mobile communication system for explaining a first embodiment of the present invention;

FIG. 2 is a view showing a communication area of the mobile communication system for explaining the first embodiment of the present invention;

FIG. 3 is a sequence chart for explaining the operation of the mobile communication system for explaining the first embodiment of the present invention;

FIG. 4 is a sequence chart for explaining the operation of the mobile communication system for explaining the first embodiment of the present invention;

FIG. 5 is a diagram showing the schematic configuration of a mobile communication system for explaining a second embodiment of the present invention;

FIG. 6 is a sequence chart for explaining the operation of the mobile communication system for explaining the second embodiment of the present invention; and

FIG. 7 is a sequence chart for explaining the operation of the mobile communication system for explaining the second embodiment of the present invention.

In the drawings, the reference numeral 101, 102 designates a cellular phone; 134, a WCDMA communication module; 136, a wireless LAN communication module; 141, a general control portion; 142, a wireless LAN communication control portion; and 143, a WCDMA communication control portion.

### BEST MODE FOR CARRYING OUT THE INVENTION

Mobile communication terminals such as cellular phones, PHS, etc. and communication management apparatuses such as servers etc. for managing communication between the mobile communication terminals will be described below with reference to the drawings. The mobile communication terminals and the communication management apparatuses are to explain embodiments of the present invention. The following description will be made on the assumption that the mobile communication terminals are cellular phones and the communication management apparatuses are servers. The cellular phones and the servers are applied to a mobile communication system which will be described below.

### First Embodiment

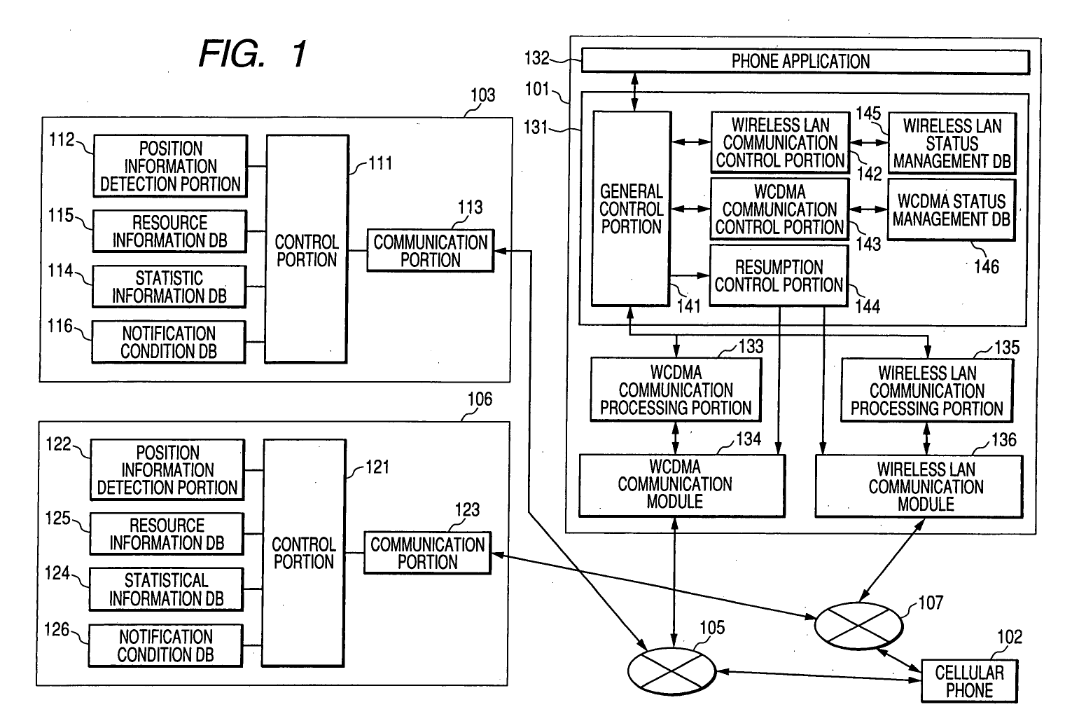

FIG. 1 is a diagram showing the schematic configuration of a mobile communication system for explaining a first embodiment of the present invention.

The mobile communication system has a configuration in which a WCDMA server 103, a cellular phone 101 serving as a source terminal, a cellular phone 102 serving as a destination terminal, and so on, are connected through a WCDMA network 105 including communication areas constructed by a plurality of base stations, a switching center, and so on, while a wireless LAN server 106, the cellular phone 101, the cellular phone 102 and so on are connected through a wireless LAN network 107 including a plurality of hot spots constructed by access points, the switching center, and so on. The WCDMA server 103 and the wireless LAN server 106 can communicate with each other through a not-shown network such as the Internet, a leased line, etc. In the following description, for the sake of convenience, the cellular phone 101 may be called a source terminal and the cellular phone 102 may be called a destination terminal.

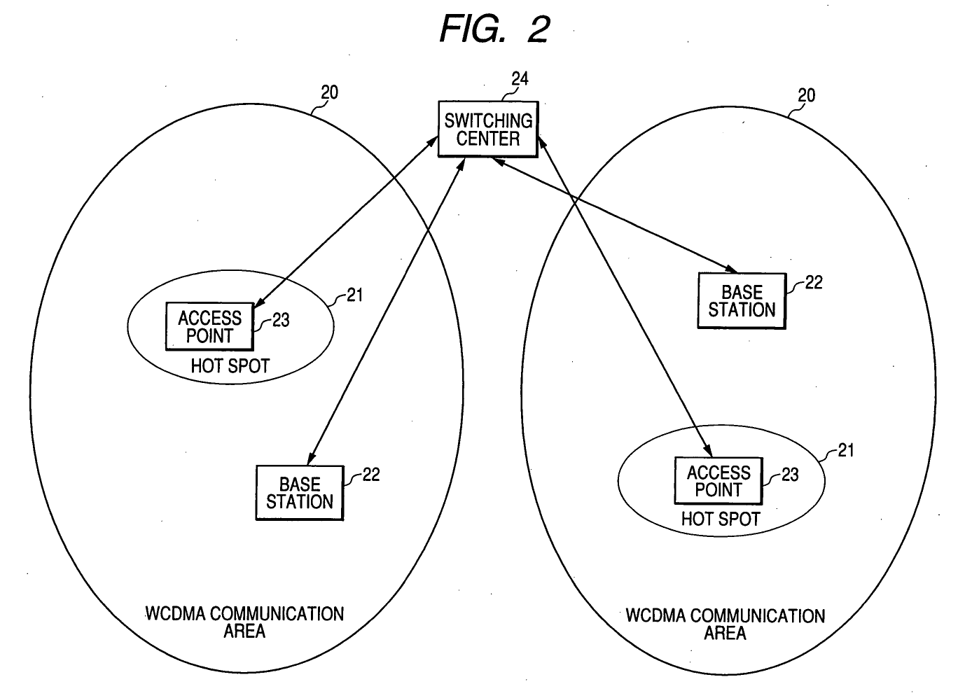

FIG. 2 is a view showing a communication area in the mobile communication system depicted in FIG. 1.

As shown in FIG. 2, the communication area in the mobile communication system depicted in FIG. 1 includes a plurality of WCDMA communication areas 20 (regions where communication using a WCDMA system can be made), and a plurality of hot spots 21 (regions where IP communication based on VoIP, SIP, etc. can be made). The WCDMA communication areas 20 are constructed by base stations 22 respectively. The hot spots 21 are constructed by access points 23 respectively. A switching center 24 connects the plurality of WCDMA communication areas 20 with one another and the plurality of hot spots 21 with one another so as to form the WCDMA network 105 and the wireless LAN network 107. As shown in FIG. 2, each hot spot 21 is a region narrower than each WCDMA communication area 20. Incidentally, WCDMA is an abbreviation for Wideband Code Division Multiple Access. VoIP is an abbreviation for Voice over Internet Protocol. SIP is an abbreviation for Session Initiation Protocol.

The WCDMA server 103 is managed by a carrier. The WCDMA server 103 includes a control portion 111, a position information detection portion 112, a communication portion 113, a statistical information database (DB) 114, a resource information database (DB) 115, and a notification condition database (DB) 116.

The position information detection portion 112 uses information (information such as radio signal strength etc.) from the base stations 22 or the switching center 24 so as to detect position information of the cellular phone 101 and the cellular phone 102 periodically.

The statistical information DB 114 stores region information expressing a location, a size, etc. of each hot spot 21 in advance. The resource information DB 115 stores resource information such as IP addresses etc. to be assigned to the cellular phone 101 and the cellular phone 102.

The control portion 111 is chiefly constituted by a processor operated by a program stored in the WCDMA server 103. The control portion 111 controls the WCDMA server 103 as a whole. The control portion 111 controls communication between the cellular phone 101 and the cellular phone 102 based on the WCDMA system through the communication portion 113.

The control portion 111 determines whether the cellular phone 101 and the cellular phone 102 are within the region of the hot spots 21 or not during communication between the cellular phone 101 and the cellular phone 102 (in the condition that the cellular phones are engaging in communication with each other by voice or packet through the WCDMA network 105 or the wireless LAN network 107), based on the position information detected by the position information detection portion 112 and the statistical information DB 114. The control portion 111 transmits notification information (source terminal within-region notification information and destination terminal within-region notification information) to the cellular phone 101 or the cellular phone 102 through the communication portion 113. This notification information is for notifying the cellular phone 101 or the cellular phone 102 of a result of the determination. The control portion 111 stores destination terminal notification registration information received from the wireless LAN server 106 into the notification condition DB 116.

A signal format of the source terminal notification information is shown in Table 1 as follows. A signal format of the destination terminal within-region notification registration information is shown in Table 2 as follows. A signal format of the destination terminal within-region notification information is shown in Table 3 as follows. An SIP SUBSCRIBE method is used for the signal format of the destination terminal notification registration information. An SIP NOTIFY method is used for the signal format of the destination terminal notification information.

TABLE 1
Identifier of cellular phone 101
or

| | |
|---|---|
| Identifier of cellular phone 101 | IP address |

TABLE 2

| | | |
|---|---|---|
| Register | Destination | Notification |
| (SUBSCRIBE) | terminal | condition |
| | identifier | identifier |

TABLE 3

| | | |
|---|---|---|
| Notify (NOTIFY) | Destination | Destination |
| | terminal is | terminal |
| | within-region | identifier |

The source terminal within-region notification information means information for notifying that the cellular phone 101 serving as the source terminal is within the region of a hot spot 21 during a call made between the cellular phone 101 and the cellular phone 102 through the WCDMA network 105. As shown in Table 1, there are two kinds of source terminal within-region notification information. One includes only an identifier (phone number etc.) of the cellular phone 101. The other includes the identifier of the cellular phone 101 serving as the source terminal, and an IP address assigned to the cellular phone 101.

The destination terminal notification registration information means information for registering the contents such as “Take a certain action when a certain condition is satisfied.” As shown in Table 2, the destination terminal notification registration information includes information such as an identifier of the cellular phone 102 serving as a destination of a call with the cellular phone 101 which is the source terminal, and information of a notification condition identifier indicating a notification condition for specifying an action to be taken when a situation happens to the destination terminal. For example, a condition “Issue notification when the destination terminal is within the region of a hot spot 21.” is set when the notification condition identifier is “01”, and a condition “Issue notification when the destination terminal is out of the region of the hot spot 21.” is set when the notification condition identifier is “02”.

The destination terminal within-region notification information means information for notifying that the cellular phone 102 serving as the destination terminal is within the region of a hot spot 21 during a call made between the cellular phone 101 and the cellular phone 102 through the WCDMA network 105. The destination terminal within-region notification information contains information indicating that the destination terminal is out of region, and the identifier of the destination terminal.

The wireless LAN server 106 has a control portion 121, a position information detection portion 122, a communication portion 123, a statistical information database (DB) 124, a resource information database (DB) 125, and a notification condition database (DB) 126.

The position information detection portion 122 uses information (information such as radio signal strength etc.) from the access points 23 or the switching center 24 so as to detect position information of the cellular phone 101 and the cellular phone 102 periodically.

The statistical information DB 124 stores region information expressing a location, a size, etc. of each hot spot 21 generated in advance based on the information (information such as radio signal strength etc.) from the access points 23 or the switching center 24. The resource information DB 125 stores resource information such as IP addresses etc. to be assigned to the cellular phone 101 and the cellular phone 102.

The control portion 121 is chiefly constituted by a processor operated by a program stored in the wireless LAN server 106. The control portion 121 controls the wireless LAN server 106 as a whole. The control portion 121 controls communication made between the cellular phone 101 and the cellular phone 102 through the wireless LAN network 107, based on SIP through the communication portion 123.

The control portion 121 determines whether the cellular phone 101 or the cellular phone 102 is out of the region of the hot spot 21 or not during communication between the cellular phone 101 and the cellular phone 102 (through the wireless LAN network 107), based on the position information detected by the position information detection portion 122 and the statistical information DB 124. The control portion 121 transmits notification information (destination terminal out-of-region notification information) to the cellular phone 101 or the cellular phone 102 from the communication portion 123. This notification information is for notifying the cellular phone 101 or the cellular phone 102 of a result of the determination. The control portion 121 stores destination terminal notification registration information received from the cellular phone 101 or the cellular phone 102 into the notification condition DB 126.

A signal format of the destination terminal out-of-region notification information is shown in Table 4 as follows. The SIP NOTIFY method is used for the signal format of the destination terminal out-of-region notification information.

TABLE 4

| | | |
|---|---|---|
| Notify (NOTIFY) | Destination | Destination |
| | terminal is out of | terminal |
| | region | identifier |

The destination terminal out-of-region notification information means information for notifying the cellular phone 101 serving as the source terminal, of the fact that the cellular phone 102 serving as the destination terminal is out of the region of the hot spot during a call between the cellular phone 101 and the cellular phone 102 through the wireless LAN network 107. As shown in Table 4, the destination terminal out-of-region notification information contains information indicating that the destination terminal is out of region, and the identifier of the destination terminal.

The communication portion 123 transfers, to the WCDMA server 103, information transmitted from the cellular phone 101 or the cellular phone 102 through the wireless LAN network 107, or transfers the information from the WCDMA server 103 to the cellular phone 101 or the cellular phone 102.

The cellular phone 101 serving as the source terminal includes a communication control management portion 131, a phone application 132, a WCDMA communication processing portion 133, a WCDMA communication module 134, a wireless LAN communication processing portion 135, and a wireless LAN communication module 136.

The communication control management portion 131 is provided with a general control portion 141, a wireless LAN communication control portion 142, a WCDMA communication control portion 143, a resumption control portion 144, a wireless LAN status management database (DB) 145, and a WCDMA status management database (DB) 146. Incidentally, since the configuration of the cellular phone 102 serving as the destination terminal is the same as that of the cellular phone 101 serving as the source terminal, description thereof will be omitted.

The phone application 132 is an application taking charge of a user interface relating to the phone.

The wireless LAN communication control portion 142 performs control on communication through the wireless LAN network 107, based on SIP. The WCDMA communication control portion 143 performs control on communication through the WCDMA network 105, based on the WCDMA system. The resumption control portion 144 controls resumption and suspension of the WCDMA communication module 134 and the wireless LAN communication module 136. The term “suspension” here does not mean entire stop but means a so-called standby state with very low power consumption.

The wireless LAN status management DB 145 manages a communication status of IP signaling using the wireless LAN. The WCDMA status management DB 146 manages a communication status by the WCDMA system.

The WCDMA communication processing portion 133 performs various kinds of signal processing such as encoding, decoding, etc. of data transmitted/received by the WCDMA communication module 134. The wireless LAN communication processing portion 135 performs various kinds of signal processing such as encoding, decoding, etc. of data transmitted/received by the wireless LAN communication module 136. The WCDMA communication module 134 is connected to the WCDMA network 105 through an antenna etc. The wireless LAN communication module 136 is connected to the wireless LAN network 107 through an antenna etc.

The general control portion 141 is chiefly constituted by a processor operated by a program stored in the cellular phone 101 serving as the source terminal.

The general control portion 141 determines whether the cellular phone 101 and the cellular phone 102 are within the region of the hot spots 21 or not during a call between the cellular phone 101 and the cellular phone 102 through the WCDMA network 105 or during a call between the cellular phone 101 and the cellular phone 102 through the wireless LAN network 107.

The general control portion 141 determines whether the cellular phone 102 serving as the destination terminal is within the region of the hot spot 21 or not during a call between the cellular phone 101 and the cellular phone 102 through the WCDMA network 105 or during a call between the cellular phone 101 and the cellular phone 102 through the wireless LAN network 107.

The general control portion 141 controls changeover between communication using the WCDMA network 105 and communication using the wireless LAN network 107, based on at least one of the two determination results.

The operation of the mobile communication system shown in FIG. 1 will be described below.

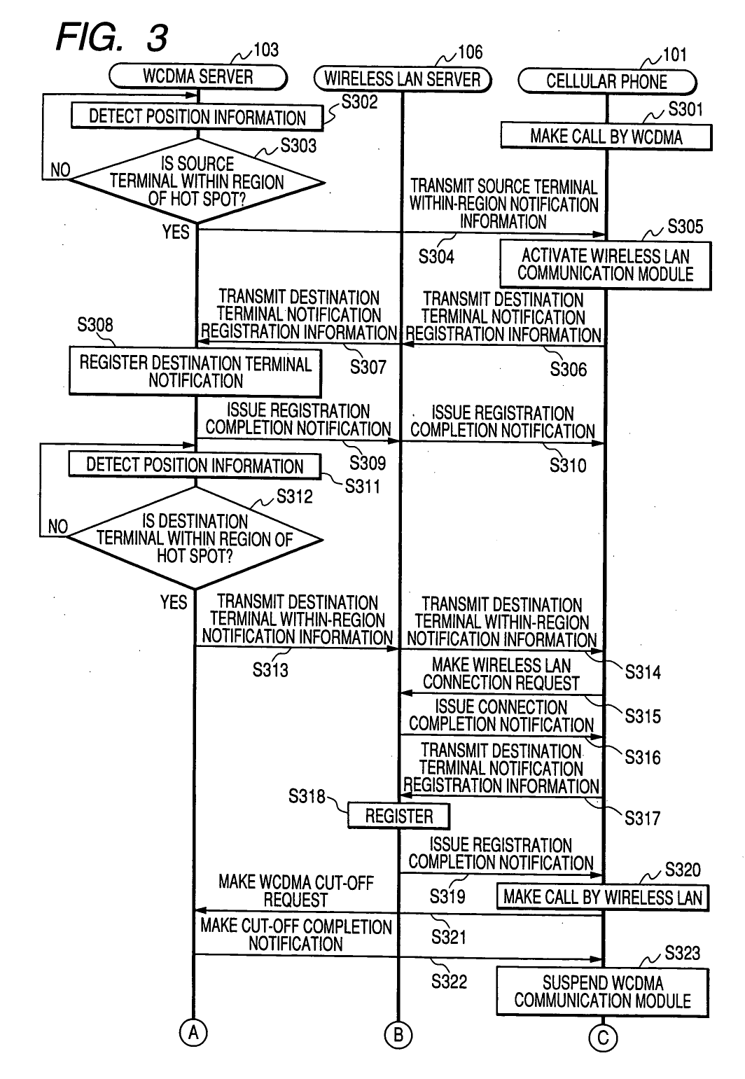

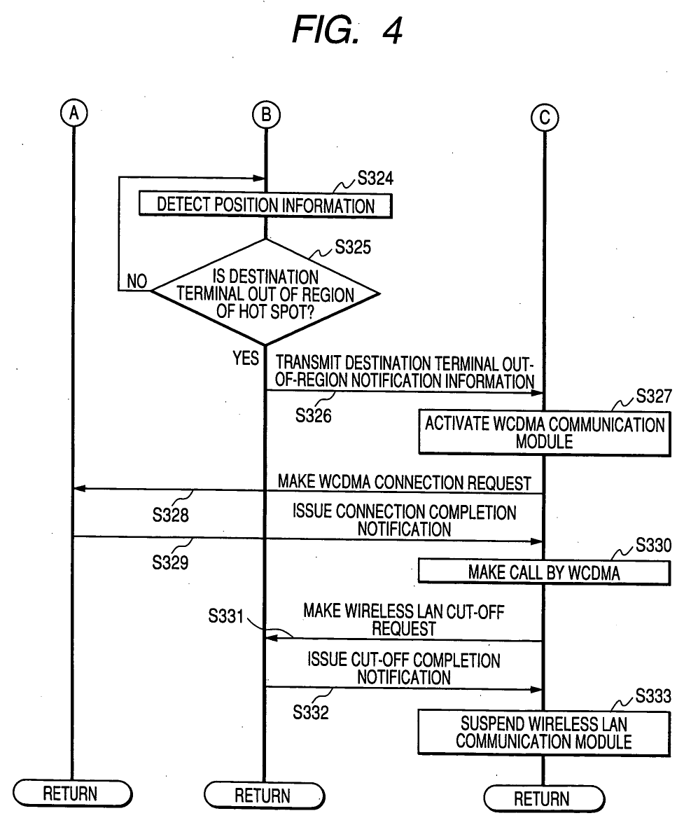

FIGS. 3 and 4 are sequence charts for explaining the operation of the mobile communication system shown in FIG. 1.

During a call between the cellular phone 101 and the cellular phone 102 through the WCDMA network 105 (S301), the WCDMA server 103 detects position information of the cellular phone 101 and the cellular phone 102 periodically (S302). Whenever the WCDMA server 103 detects the position information, the WCDMA server 103 determines whether the cellular phone 101 serving as the source terminal is within the region of a hot spot 21 or not, based on the detected position information and region information stored in the statistical information DB 114.

Assume that the position information of the cellular phone 101 serving as the source terminal enters the hot spot 21 based on the region information, and the WCDMA server 103 concludes that the cellular phone 101 serving as the source terminal is within the region of the hot spot 21 (S303: YES). In this case, the WCDMA server 103 generates source terminal within-region notification information, and transmits the generated source terminal within-region notification information to the cellular phone 101 as the source terminal through the WCDMA network 105 (S304). A multicall function of the WCDMA is used for transmitting the source terminal within-region notification information. The transmission is performed by the initiative of the WCDMA server 103 side, similarly to function of a mail push. On the contrary, assume that the position information of the cellular phone 101 serving as the source terminal does not enter the hot spot 21 based on the region information, and the WCDMA server 103 concludes that the cellular phone 101 serving as the source terminal is out of the region of the hot spot 21 (S303: NO). In this case, the WCDMA server 103 repeats detection of the position information.

Assume that the general control portion 141 of the cellular phone 101 serving as the source terminal receives the source terminal within-region notification information from the WCDMA server 103 after the cellular phone 101 and the cellular phone 102 initiate a call through the WCDMA network 105. In this case, the general control portion 141 concludes that the cellular phone 101 serving as the source terminal is within the region of the hot spot 21. When the general control portion 141 does not receive the source terminal within-region notification information from the WCDMA server 103, the general control portion 141 concludes that the cellular phone 101 serving as the source terminal is out of the region of the hot spot.

When the general control portion 141 of the cellular phone 101 serving as the source terminal has received the source terminal within-region notification information, the general control portion 141 concludes that the cellular phone 101 serving as the source terminal is within the region of the hot spot 21, and the general control portion 141 issues an instruction to the resumption control portion 144 to activate the wireless LAN communication module 136 which is in suspension (S305). On the other hand, when the general control portion 141 has not received the source terminal within-region notification information, the cellular phone 101 serving as the source terminal does not activate the wireless LAN communication module 136 but continues the call made through the WCDMA network 105.

When the source terminal within-region notification information contains only source terminal identification information, the cellular phone 101 serving as the source terminal acquires an IP address by DHCP after the resumption of the wireless LAN communication module 136, and sets the acquired IP address on the wireless LAN communication module 136. When the source terminal within-region notification information also contains an IP address, the cellular phone 101 serving as the source terminal sets the IP address contained in the source terminal within-region notification information on the wireless LAN communication module 136 after the resumption of the wireless LAN communication module 136.

Then, the general control portion 141 generates destination terminal notification registration information with a notification condition identifier set as “01”. The general control portion 141 gives the wireless LAN communication control portion 142 an instruction to transmit the generated destination terminal notification registration information to the wireless LAN server 106. As a result, the destination terminal notification registration information is transmitted from the wireless LAN communication module 136 to the wireless LAN server 106 (S306).

The wireless LAN server 106 having received the destination terminal notification registration information transmits the destination terminal notification registration information to the WCDMA server 103 because the notification condition identifier contained in the destination terminal notification registration information is “01” (S307).

The WCDMA server 103 registers the received destination terminal notification registration information on the notification condition DB (S308), and transmits a registration completion signal to the wireless LAN server 106 (S309). The wireless LAN server 106 transmits the received registration completion signal to the cellular phone 101 serving as the source terminal (S310).

Then, the WCDMA server 103 detects the position information of the cellular phone 101 and the cellular phone 102 periodically (S311). Whenever the WCDMA server 103 detects the position information, the WCDMA server 103 determines whether the cellular phone 102 serving as the destination terminal is within the region of a hot spot 21 or not, based on the detected position information and region information stored in the statistical information DB 114.

Assume that the position information of the cellular phone 102 serving as the destination terminal enters the hot spot 21 based on the region information, and the WCDMA server 103 concludes that the cellular phone 102 serving as the destination terminal is within the region of the hot spot 21 (S312: YES). In this case, the WCDMA server 103 generates destination terminal within-region notification information, and transmits the generated destination terminal within-region notification information to the wireless LAN server 106 (S313). The wireless LAN server 106 transmits the received destination terminal within-region notification information to the cellular phone 101 serving as the source terminal (S314). On the contrary, assume that the position information of the cellular phone 102 serving as the destination terminal does not enter the hot spot 21 based on the region information, and the WCDMA server 103 concludes that the cellular phone 102 serving as the destination terminal is out of the region of the hot spot 21 (S312: NO), the WCDMA server 103 repeats detection of the position information.

When the general control portion 141 receives the destination terminal within-region notification information from the wireless LAN server 106, the general control portion 141 concludes that the cellular phone 102 serving as the destination terminal is within the region of the hot spot 21, and gives the wireless LAN communication control portion 142 an instruction to connect the cellular phone 101 and the cellular phone 102 through the wireless LAN network 107. On the other hand, when the general control portion 141 does not receive the destination terminal within-region notification information from the wireless LAN server 106, the general control portion 141 concludes that the cellular phone 102 serving as the destination terminal is out of the region of the hot spot 21, and continues the call through the WCDMA network 105.

In accordance with the instruction, the wireless LAN communication control portion 142 performs control for establishing line connection between the cellular phone 101 and the cellular phone 102 through the wireless LAN network 107, so that a wireless LAN connection request is made to the wireless LAN server 106 from the cellular phone 101 serving as the source terminal (S315). As a signal format of the wireless LAN connection request, an SIP INVITE method is used.

In accordance with the wireless LAN connection request, the wireless LAN server 106 issues an instruction to the switching center 24 to establish line connection between the cellular phone 101 and the cellular phone 102 through the wireless LAN network 107. When the line connection is completed, the wireless LAN server 106 transmits a connection completion signal to the cellular phone 101 serving as the source terminal (S316). As a format of the connection completion signal, a response (message) of SIP “200 OK” is used.

When the general control portion 141 of the cellular phone 101 serving as the source terminal has received the connection completion signal, the general control portion 141 generates destination terminal notification registration information with the notification condition identifier set as “02”. The general control portion 141 gives the wireless LAN communication control portion 142 an instruction to transmit the generated destination terminal notification registration information to the wireless LAN server 106. As a result, the destination terminal notification registration information is transmitted to the wireless LAN server 106 from the wireless LAN communication module 136 (S317).

The wireless LAN server 106 having received the destination terminal notification registration information registers the destination terminal notification registration information on the notification condition DB 126 (S318) because the notification condition identifier contained in the destination terminal notification registration information is “02”. The wireless LAN server 106 transmits a registration completion signal to the cellular phone 101 serving as the source terminal (S319).

When the registration completion signal has been received by the cellular phone 101 serving as the source terminal, the general control portion 141 gives the wireless LAN communication control portion 142 and the WCDMA communication control portion 143 an instruction to make the wireless LAN communication module 136 transmit/receive voice data which have been transmitted/received by the WCDMA communication module 134. As a result, the call between the cellular phone 101 and the cellular phone 102 is changed over from a call through the WCDMA network 105 to a call through the wireless LAN network 107 (S320).

The general control portion 141 then gives the WCDMA communication control portion 143 an instruction to cut off the line connected between the cellular phone 101 and the cellular phone 102 through the WCDMA network 105. In accordance with this instruction, the WCDMA communication control portion 143 performs control for cutting off the line connected between the cellular phone 101 and the cellular phone 102 through the WCDMA network 105, so that a WCDMA cut-off request is made to the WCDMA server 103 from the cellular phone 101 serving as the source terminal (S321). As a signal format of this WCDMA cut-off request, a signal format as defined in the 3GPP specification is used.

In accordance with the WCDMA cut-off request, the WCDMA server 103 issues an instruction to the switching center 24 to cut off the line connected between the cellular phone 101 and the cellular phone 102 through the WCDMA network 105. After the line cut-off has been completed, the WCDMA server 103 deletes the contents registered in S308 and transmits a cut-off completion signal to the cellular phone 101 serving as the source terminal (S322). As a format of this cut-off completion signal, a signal format as defined in the 3GPP specification is used.

When the general control portion 141 of the cellular phone 101 serving as the source terminal has received the cut-off completion signal, the general control portion 141 issues an instruction to the resumption control portion 144 to suspend the WCDMA communication module 134 (S323).

During the call between the cellular phone 101 and the cellular phone 102 through the wireless LAN network 107, the wireless LAN server 106 periodically detects the position information of the cellular phone 102 serving as the destination terminal (S324). Whenever the wireless LAN server 106 detects the position information, the wireless LAN server 106 determines whether the cellular phone 102 serving as the destination terminal is out of the region of the hot spot 21 or not, based on the detected position information and the region information stored in the statistical information DB 124.

Assume that the position information of the cellular phone 102 serving as the destination terminal dose not enter the hot spot 21 based on the region information, and the wireless LAN server 106 concludes that the cellular phone 102 serving as the destination terminal is out of the region of the hot spot 21 (S325: YES). In this case, the wireless LAN server 106 generates destination terminal out-of-region notification information, and transmits the generated destination terminal out-of-region notification information to the cellular phone 101 as the source terminal through the wireless LAN network 107 (S326). On the contrary, assume that the position information of the cellular phone 102 serving as the destination terminal enters the hot spot 21 based on the region information, and the wireless LAN server 106 concludes that the cellular phone 102 serving as the destination terminal is within the region of the hot spot 21 (S325: NO). In this case, the wireless LAN server 106 repeats detection of the position information.

When the general control portion 141 has received the destination terminal out-of-region notification information from the wireless LAN server 106, the general control portion 141 concludes that the cellular phone 102 serving as the destination terminal is out of the region of the hot spot 21, and issues an instruction to the resumption control portion 144 to activate the WCDMA communication module 134 (S327). On the other hand, when the general control portion 141 has not received the destination terminal out-of-region notification information from the wireless LAN server 106, the general control portion 141 concludes that the cellular phone 102 serving as the destination terminal is within the region of the hot spot 21. Thus, the general control portion 141 does not activate the WCDMA communication module 134 but continues the call made through the wireless LAN network 107.

After the resumption of the WCDMA communication module 134, the general control portion 141 gives the WCDMA communication control portion 143 an instruction to connect the cellular phone 101 and the cellular phone 102 through the WCDMA network 105. In accordance with the instruction, the WCDMA communication control portion 143 performs control for establishing line connection between the cellular phone 101 and the cellular phone 102 through the WCDMA network 105 so that a WCDMA connection request is made to the WCDMA server 103 from the cellular phone 101 serving as the source terminal (S328).

In accordance with the WCDMA connection request, the WCDMA server 103 issues an instruction to the switching center 24 to establish line connection between the cellular phone 101 and the cellular phone 102 through the WCDMA network 105. When the line connection is completed, the WCDMA server 103 transmits a connection completion signal to the cellular phone 101 serving as the source terminal (S329).

When the general control portion 141 of the cellular phone 101 serving as the source terminal has received the connection completion signal, the general control portion 141 gives the wireless LAN communication control portion 142 and the WCDMA communication control portion 143 an instruction to make the WCDMA communication module 134 transmit/receive voice data which have been transmitted/received by the wireless LAN communication module 136. As a result, the call between the cellular phone 101 and the cellular phone 102 is changed over from a call through the wireless LAN network 107 to a call through the WCDMA network 105 (S330).

The general control portion 141 then gives the wireless LAN communication control portion 142 an instruction to cut off the line connected between the cellular phone 101 and the cellular phone 102 through the wireless LAN network 107. In accordance with this instruction, the wireless LAN communication control portion 142 performs control for cutting off the line connected between the cellular phone 101 and the cellular phone 102 through the wireless LAN network 107, so that a wireless LAN cut-off request is made to the wireless LAN server 106 from the cellular phone 101 serving as the source terminal (S331). As a signal format of this wireless LAN cut-off request, an SIP BYE method is used.

In accordance with the wireless LAN cut-off request, the wireless LAN server 106 issues an instruction to the switching center 24 to cut off the line connected between the cellular phone 101 and the cellular phone 102 through the wireless LAN network 107. After the line cut-off has been completed, the wireless LAN server 106 transmits a cut-off completion signal to the cellular phone 101 serving as the source terminal (S332).

When the general control portion 141 of the cellular phone 101 serving as the source terminal has received the cut-off completion signal, the general control portion 141 issues an instruction to the resumption control portion 144 to suspend the wireless LAN communication module 136 (S333). In this manner, in the mobile communication system, the process is repeated during the call between the cellular phone 101 and the cellular phone 102.

As described above, according to the mobile communication system depicted in FIG. 1, in the condition that geographically narrow hot spots 21 are scattered in geographically wide WCDMA areas 20, the cellular phone 101 and the cellular phone 102 having a call therebetween through the WCDMA network 105 can change over the call to a call through the wireless LAN network 107 cheaper in charge than the call through the WCDMA network 105. When the cellular phone 102 serving as the destination terminal goes out of the region of the hot spot 21 during the call through the wireless LAN network 107, the call can be changed over from the call through the wireless LAN network 107 to a call through the WCDMA network 105.

Thus, users of the cellular phone 101 and the cellular phone 102 moving relative to each other can change over a call therebetween to a call through the WCDMA network 105 or a call through the wireless LAN network 107 in accordance with the condition. Accordingly, it is possible to attain service advantageous to the users.

In addition, when the call is changed over from a call through the WCDMA network 105 to a call through the wireless LAN network 107, the line using the WCDMA network 105 is cut off after the line connection using the wireless LAN network 107 is completed. Thus, it is possible to prevent the call between the cellular phone 101 and the cellular phone 102 from being disconnected.

In addition, the WCDMA communication module 134 and the wireless LAN communication module 136 are activated only when the occasion demands. Accordingly, it is possible to reduce the power consumption of the cellular phone 101 serving as the source terminal, so that it is possible to elongate a call time and a standby time.

In the above description, the WCDMA server 103 determines whether the cellular phone 101 serving as the source terminal enters the region of a hot spot 21 during a call made between the cellular phone 101 and the cellular phone 102 through the WCDMA network 105, and the WCDMA server 103 notifies the cellular phone 101 as the source terminal, of the result of the determination. However, the cellular phone 101 serving as the source terminal may have a function equivalent to that of the WCDMA server 103. In this case, for example, the general control portion 141 of the cellular phone 101 serving as the source terminal may determine whether the cellular phone 101 serving as the source terminal is within the region of a hot spot 21 or not, based on position information and region information of the hot spot 21, during a call made with the cellular phone 102 as the destination terminal through the WCDMA network 105. The position information is received from a GPS receiver etc. of the cellular phone 101 serving as the source terminal. The region information of the hot spot 21 is stored in advance in the cellular phone 101 serving as the source terminal.

Although the WCDMA server 103 and the wireless LAN server 106 are provided separately in the above description, the both may be implemented by one server.

### Second Embodiment

The first embodiment has been described about an example in which a call between the cellular phone 101 and the cellular phone 102 is changed over from a call through the wireless LAN network 107 to a call through the WCDMA network 105 when the cellular phone 102 serving as the destination terminal goes out of the region of the hot spot 21 during the call between the cellular phone 101 and the cellular phone 102 through the wireless LAN network 107. This second embodiment will be described about an example in which a call between the cellular phone 101 and the cellular phone 102 is changed over from a call through the wireless LAN network 107 to a call through the WCDMA network 105 when the cellular phone 101 serving as the source terminal goes out of the region of the hot spot 21 during the call between the cellular phone 101 as the source terminal and the cellular phone 102 through the wireless LAN network 107.

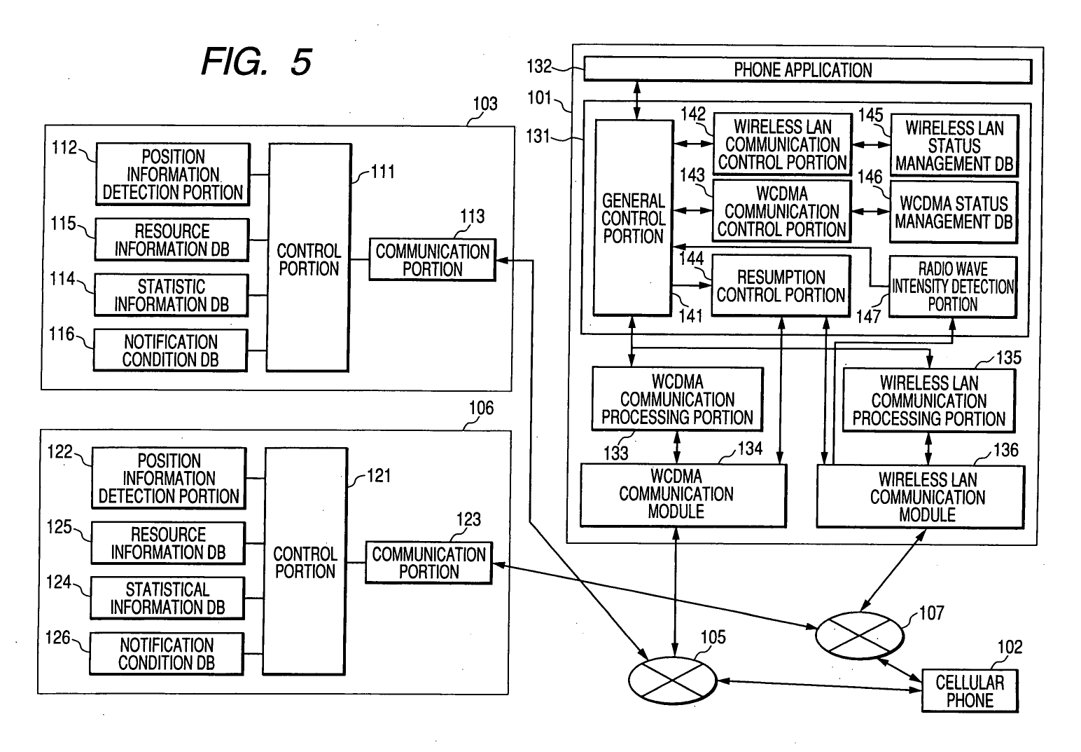

FIG. 5 is a diagram showing the schematic configuration of a mobile communication system for explaining the second embodiment of the present invention. Parts the same in configuration as those is FIG. 1 are denoted by the same reference numerals correspondingly, and description thereof will be omitted.

In the mobile communication system shown in FIG. 5, a radio wave intensity detection portion 147 is added to the configuration of the cellular phone 101 which is the source terminal in the mobile communication system shown in FIG. 1. The radio wave intensity detection portion 147 detects intensity of a radio wave received by the wireless LAN communication module 136 while communication with the cellular phone 102 as the destination terminal is being made by the wireless LAN communication module 136. The radio wave intensity detection portion 147 notifies the general control portion 141 of the detected radio wave intensity information.

The general control portion 141 monitors the radio wave intensity information notified from the radio wave intensity detection portion 147 during a call made between the cellular phone 101 and the cellular phone 102 through the wireless LAN network 107. When the radio wave intensity is not higher than a predetermined value, the general control portion 141 concludes that the cellular phone 101 serving as the source terminal is out of the region of the hot spot 21. When the radio wave intensity is higher than the predetermined value, the general control portion 141 concludes that the cellular phone 101 serving as the source terminal is within the region of the hot spot 21.

The operation of the mobile communication system for explaining the second embodiment of the present invention will be described below.

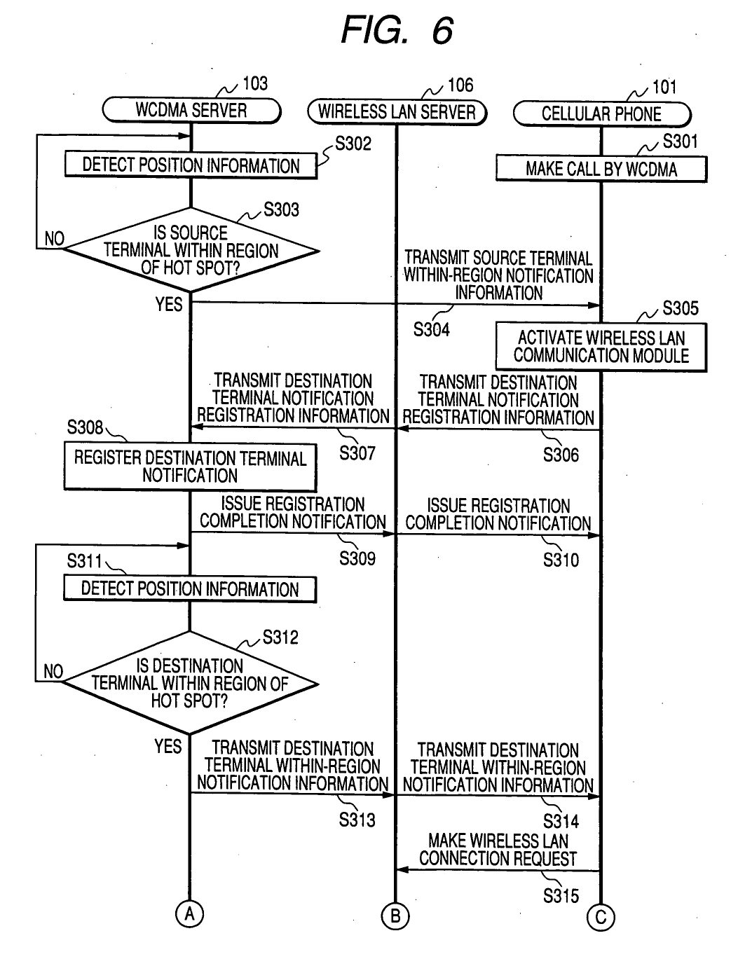

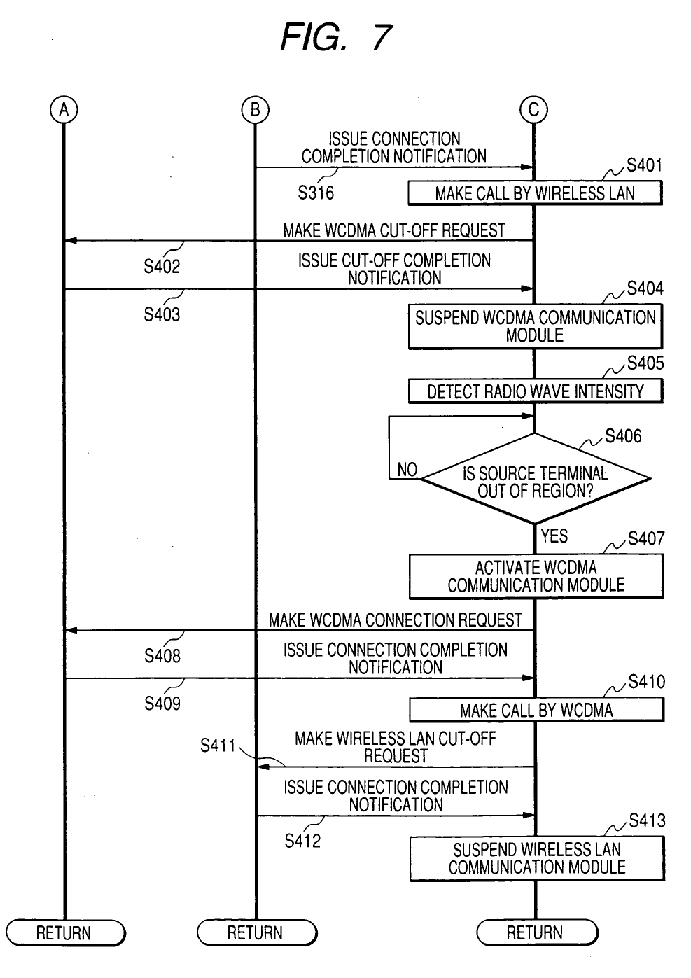

FIGS. 6 and 7 are sequence charts for explaining the operation of the mobile communication system for explaining the second embodiment of the present invention. Sequences identical to those in FIGS. 3 and 4 are denoted by the same reference numerals correspondingly, and description thereof will be omitted.

When the general control portion 141 receives a connection completion notification from the wireless LAN server 106 (S316), the general control portion 141 gives the wireless LAN communication control portion 142 and the WCDMA communication control portion 143 an instruction to make the wireless LAN communication module 136 transmit/receive voice data which have been transmitted/received by the WCDMA communication module 134. As a result, the call between the cellular phone 101 and the cellular phone 102 is changed over from a call through the WCDMA network 105 to a call through the wireless LAN network 107 (S401).

Then, the general control portion 141 gives the WCDMA communication control portion 143 an instruction to cut off a line connected between the cellular phone 101 and the cellular phone 102 through the WCDMA network 105. In accordance with this instruction, the WCDMA communication control portion 143 performs control for cutting off the line connected between the cellular phone 101 and the cellular phone 102 through the WCDMA network 105, so that a WCDMA cut-off request is made from the cellular phone 101 serving as the source terminal to the WCDMA server 103 (S402). As a signal format of this WCDMA cut-off request, a signal format as defined in the 3GPP specification is used.

In accordance with the WCDMA cut-off request, the WCDMA server 103 issues an instruction to the switching center 24 to cut off the line connected between the cellular phone 101 and the cellular phone 102 through the WCDMA network 105. After the line cut-off has been completed, the WCDMA server 103 deletes the contents registered in S308 and transmits a cut-off completion signal to the cellular phone 101 serving as the source terminal (S403). As a format of the cut-off completion signal, a signal format as defined in the 3GPP specification is used.

When the general control portion 141 of the cellular phone 101 serving as the source terminal has received the cut-off completion signal, the general control portion 141 issues an instruction to the resumption control portion 144 to suspend the WCDMA communication module 134 (S404).

During the call between the cellular phone 101 and the cellular phone 102 through the wireless LAN network 107, the cellular phone 101 serving as the source terminal periodically detects the radio wave intensity received by the wireless LAN communication module 136 (S405).

The general control portion 141 determines whether the cellular phone 101 serving as the source terminal is out of the region of the hot spot 21 or not, based on the detected radio wave intensity. When the general control portion 141 concludes that the cellular phone 101 serving as the source terminal is out of the region of the hot spot 21 (S406: YES), the general control portion 141 gives the resumption control portion 144 an instruction to activate the WCDMA communication module 134 (S407). On the other hand, when the general control portion 141 concludes that the cellular phone 101 serving as the source terminal is within the region of the hot spot 21 (S406: NO), the general control portion 141 repeats the determination.

After the resumption of the WCDMA communication module 134, the general control portion 141 gives the WCDMA communication control portion 143 an instruction to connect the cellular phone 101 and the cellular phone 102 through the WCDMA network 105. In accordance with the instruction, the WCDMA communication control portion 143 performs control for establishing line connection between the cellular phone 101 and the cellular phone 102 through the WCDMA network 105, so that a WCDMA connection request is made to the WCDMA server 103 from the cellular phone 101 serving as the source terminal (S408).

In accordance with the WCDMA connection request, the WCDMA server 103 issues an instruction to the switching center 24 to establish line connection between the cellular phone 101 and the cellular phone 102 through the WCDMA network 105. When the line connection is completed, the WCDMA server 103 transmits a connection completion signal to the cellular phone 101 serving as the source terminal (S409).

When the general control portion 141 of the cellular phone 101 serving as the source terminal has received the connection completion signal, the general control portion 141 gives the wireless LAN communication control portion 142 and the WCDMA communication control portion 143 an instruction to make the WCDMA communication module 134 transmit/receive voice data which have been transmitted/received by the wireless LAN communication module 136. As a result, the call between the cellular phone 101 and the cellular phone 102 is changed over from a call through the wireless LAN network 107 to a call through the WCDMA network 105 (S410).

The general control portion 141 gives the wireless LAN communication control portion 142 an instruction to cut off the line connected between the cellular phone 101 and the cellular phone 102 through the wireless LAN network 107. In accordance with this instruction, the wireless LAN communication control portion 142 performs control for cutting off the line connected between the cellular phone 101 and the cellular phone 102 through the wireless LAN network 107, so that a wireless LAN cut-off request is made to the wireless LAN server 106 from the cellular phone 101 serving as the source terminal (S411). As a signal format of the wireless LAN cut-off request, an SIP BYE method is used.

In accordance with the wireless LAN cut-off request, the wireless LAN server 106 issues an instruction to the switching center 24 to cut off the line connected between the cellular phone 101 and the cellular phone 102 through the wireless LAN network 107. After the line cut-off has been completed, the wireless LAN server 106 transmits a cut-off completion signal to the cellular phone 101 serving as the source terminal (S412).

When the general control portion 141 of the cellular phone 101 serving as the source terminal has received the cut-off completion signal, the general control portion 141 issues an instruction to the resumption control portion 144 to suspend the wireless LAN communication module 136 (S413). In this manner, in the mobile communication system, the process is repeated during the call made between the cellular phone 101 and the cellular phone 102.

As described above, according to the mobile communication system shown in FIG. 5, when the cellular phone 101 serving as the source terminal is out of the region of the hot spot 21 during a call between the cellular phone 101 and the cellular phone 102 through the wireless LAN network 107, the call between the cellular phone 101 and the cellular phone 102 is changed over from the call through the wireless LAN network 107 to a call through the WCDMA network 105. Thus, even if one of the users making a call with each other goes out of the region of the hot spot 21, the call between the users can be continued. Accordingly, the users having the call therebetween can talk with each other while moving freely.

Incidentally, the general control portion 141 concludes that the cellular phone 101 serving as the source terminal is out of the region of the hot spot 21, when the radio wave intensity detected by the radio wave intensity detection portion 147 is not higher than a predetermined value. However, the general control portion 141 may conclude that the cellular phone 101 serving as the source terminal is out of the region of the hot spot 21, when a status in which the radio wave intensity is not higher than a predetermined value has occurred a predetermined number of times within a predetermined time.

In addition, the wireless LAN server 106 may acquire information about the radio wave intensity of the cellular phone 101 as the source terminal from the access point 23 or the switching center 24, determine whether the cellular phone 101 serving as the source terminal is out of the region of the hot spot 21 based on the acquired information, and notify the cellular phone 101 as the source terminal, of the determination result. When there is a notification, the cellular phone 101 serving as the source terminal may conclude that the source terminal itself is out of the region of the hot spot 21, and perform the process from S407 to S413.

Although the first embodiment and the second embodiment have been described in the case where a call is being made between the cellular phone 101 and the cellular phone 102 by way of example, the invention is not limited to the call but can also obtain a similar effect even in data communication.

In the description of the first embodiment and the second embodiment, “the cellular phone 101 serving as the source terminal is within the region of the hot spot 21” indicates that the cellular phone 101 serving as the source terminal is in a status where communication using the wireless LAN communication module 136 can be made, and “the cellular phone 101 serving as the source terminal is out of the region of the hot spot 21” indicates that the cellular phone 101 serving as the source terminal is in a status where communication made using the wireless LAN communication module 136 cannot be made. It is assumed that the status where communication using the wireless LAN communication module 136 cannot be made includes a status where communication can be made currently but will be not able to be made in a predetermined time.

In the description of the first embodiment and the second embodiment, changeover between communication through the WCDMA network and communication through the wireless LAN network is made by resumption/suspension of the wireless LAN communication module. However, changeover of the communication can be made using Sleep/WakeUP of the wireless LAN communication module.

Although the first embodiment and the second embodiment have been described about the case between the WCDMA network and the wireless LAN network, the present invention can be also applied to the case between wireless LAN networks or between other networks.

In addition, the first embodiment and the second embodiment have been described about an example in which communication between the cellular phone 101 and the cellular phone 102 through the wireless LAN network 107 is established based on SIP. However, the communication can be established by any other protocol having a similar function.

Although the present invention has been described above in detail and with reference to its specific embodiments, it is obvious to those skilled in the art that various changes or modifications can be made without departing from the spirit and scope of the present invention.

The present application is based on Japanese Patent Application No. 2003-368461 filed on Oct. 29, 2003, the contents of which are incorporated herein by reference.

### INDUSTRIAL APPLICABILITY

According to the present invention, it is possible to provide a mobile communication terminal which is capable of changing over from communication using a current communication system to communication using another communication system while taking a status of a destination terminal engaging in communication into consideration, and communication management apparatus for managing communication made by the mobile communication terminal.

1. A mobile communication terminal capable of performing communication by a plurality of communication systems which include a first communication system and a second communication system, a first wireless communication region in which communication can be made by the first communication system is wider than a second wireless communication region in which communication can be made by the second communication system, the mobile communication terminal comprising:
a first communication unit which performs communication with a destination terminal by the first communication system;
a second communication unit which performs communication with the destination terminal by the second communication system;
a first determination unit which determines whether the mobile communication terminal is within the second wireless communication region or not during communication with the destination terminal;
a second determination unit which determines whether the destination terminal is within the second wireless communication region or not during communication with the destination terminal; and
a communication changeover control unit which performs control to change over between communication using the first communication unit and communication using the second communication unit, based on at least one of a determination result of the first determination unit and a determination result of the second determination unit.

2. The mobile communication terminal according to claim 1,
wherein the communication changeover control unit performs control to change over from communication using the first communication unit to communication using the second communication unit when the first determination unit concludes that the mobile communication terminal is within the second wireless communication region during communication with the destination terminal by the first communication unit and the second determination unit concludes that the destination terminal is within the second wireless communication region.

3. The mobile communication terminal according to claim 2,
wherein the communication changeover control unit performs control to cut off a line connected to the destination terminal by the first communication unit after line connection to the destination terminal by the second communication unit is completed.

4. The mobile communication terminal according to claim 3, further comprising:
a resumption control unit which resumes the second communication unit when the first determination unit concludes that the mobile communication terminal is within the second wireless communication region during communication with the destination terminal by the first communication unit, and suspending the first communication unit after the line connected to the destination terminal by the first communication unit is cut off.

5. The mobile communication terminal according to claim 1,
wherein the communication changeover control unit performs control to change over from communication using the second communication unit to communication using the first communication unit when the first determination unit concludes that the mobile communication terminal is out of the second wireless communication region during communication with the destination terminal by the second communication unit.

6. The mobile communication terminal according to claim 1,
wherein the communication changeover control unit performs control to change over from communication using the second communication unit to communication using the first communication unit when the second determination unit concludes that the destination terminal is out of the second wireless communication region during communication with the destination terminal by the second communication unit.

7. The mobile communication terminal according to claim 5,
wherein the communication changeover control unit performs control to cut off the line connected to the destination terminal by the second communication unit after the line connection to the destination terminal by the first communication unit is completed.

8. The mobile communication terminal according to claim 6,
wherein the communication changeover control unit performs control to cut off the line connected to the destination terminal by the second communication unit after the line connection to the destination terminal by the first communication unit is completed.

9. The mobile communication terminal according to claim 7, further comprising:
a resumption control unit which resumes the first communication unit when the first determination unit concludes that the mobile communication terminal is out of the second wireless communication region during communication with the destination terminal by the second communication unit, and suspending the second communication unit after the line connected to the destination terminal by the second communication is cut off.

10. The mobile communication terminal according to claim 8, further comprising:
a resumption control unit which resumes the first communication unit when the second determination unit concludes that the destination terminal is out of the second wireless communication region during communication with the destination terminal by the second communication unit, and suspending the second communication unit after the line connected to the destination terminal by the second communication is cut off.

11. The mobile communication terminal according to claim 1,
wherein the first determination unit determines that the mobile communication terminal is within the second wireless communication region during communication with the destination terminal by the first communication unit, based on mobile communication terminal within-region notification information for notifying that the mobile communication terminal is within the second wireless communication region, the notification information being sent from communication management apparatus for managing communication between the mobile communication terminal and the destination terminal, and
wherein the second determination unit determines that the destination terminal is within the second wireless communication region during communication with the destination terminal by the first communication unit, based on destination terminal within-region notification information for notifying that the destination terminal is within the second wireless communication region, the notification information being sent from the communication management apparatus.

12. The mobile communication terminal according to claim 1, further comprising:
a radio wave intensity detection unit which detects intensity of a radio wave received by the second communication unit during communication with the destination terminal through the second communication unit,
wherein the first determination unit determines whether the mobile communication terminal is within the second wireless communication region or not during communication with the destination terminal by the second communication unit, based on the radio wave intensity detected by the radio wave intensity detection unit.

13. The mobile communication terminal according to claim 1,
wherein the second determination unit concludes that the destination terminal is out of the second wireless communication region during communication with the destination terminal by the second communication unit, based on destination terminal out-of-region notification information for notifying that the destination terminal is out of the second wireless communication region, the notification information being sent from communication management apparatus for managing communication between the mobile communication terminal and the destination terminal.

14. The mobile communication terminal according to claim 1,
wherein the second communication system is a communication system based on SIP.

15. A communication management apparatus for managing communication between two mobile communication terminals performing the communication by a plurality of communication systems,
wherein the two mobile communication terminals are set as a source terminal and a destination terminal respectively,
wherein the plurality of communication systems include a first communication system and a second communication system, a first wireless communication region in which communication can be made by the first communication system is wider than a second wireless communication region in which communication can be made by the second communication system, and
wherein the communication management apparatus comprises:
a position information detection unit which detects position information of the source terminal and the destination terminal;
a within-region determination unit which determines whether the source terminal and the destination terminal are within the second wireless communication region or not during communication between the source terminal and the destination terminal, based on region information of the second wireless communication region and the position information; and
a notification information transmission unit which transmits the source terminal notification information for notifying a determination result of the within-region determination unit.

16. The communication management apparatus according to claim 15,
wherein the notification information contains source terminal within-region notification information for notifying that the source terminal is within the second wireless communication region during communication between the source terminal and the destination terminal by the first communication system, and destination terminal within-region notification information for notifying that the destination terminal is within the second wireless communication region during communication between the source terminal and the destination terminal by the first communication system.

17. The communication management apparatus according to claim,
wherein the notification information contains destination terminal out-of-region notification information for notifying that the destination terminal is out of the second wireless communication region during communication between the source terminal and the destination terminal by the second communication system.

18. The communication management apparatus according to claim 15, wherein the second communication system is a communication system based on SIP.
